(19) United States
(12) Patent Application Publication
(10) Pub. No.: US 2018/0032697 A1
(43) Pub. Date: Feb. 1, 2018

(54) HEALTH TRACKING SYSTEM WITH SMART SERVING SIZES

(71) Applicant: Under Armour, Inc., Baltimore, MD (US)

(72) Inventors: CHUL LEE, San Francisco, CA (US); MIRELA SPASOVA, San Francisco, CA (US)

(21) Appl. No.: 15/225,535

(22) Filed: Aug. 1, 2016

(51) Int. Cl. G06F 19/00

(52) U.S. Cl. CPC G06F 19/3431; G06F 19/322; G06F 19/345

(57) ABSTRACT

A method of providing nutritional data comprises: receiving a selection of a consumable item having a descriptor from a health tracking device; associating the selected consumable item with a consumable record in a database based on a comparison of the descriptor to a descriptive string for of the consumable record; obtaining from the consumable record a first serving size for the selected consumable item; calculating a second serving size for the selected consumable, the second serving size having a different unit of measurement than the first serving size; and providing the first serving size and the second serving size to the health tracking device.

### FIELD

The method and system disclosed in this document relate to health and fitness tracking devices and, more particularly, to devices configured to collect and display nutritional information.

### BACKGROUND

Health and fitness tracking devices are increasingly utilized by individuals interested in tracking metrics related to their personal health and fitness.

Challenges exist with entry of foods and beverages and related calorie and nutritional data. In particular, the user must manually log this data into the health tracking system in order for the system to properly monitor calorie consumption and nutritional health. This process of manually entering food and beverage consumption into the system along with calorie and nutritional data is often time consuming and cumbersome. Moreover, it is often difficult for users to accurately determine the calorie and nutritional content of the foods and beverages they consume, so the calorie consumption and nutritional data entered into the health tracking system is often inaccurate.

In view of the foregoing, it would be advantageous to provide a health tracking system and related method that allows a user to log meals in terms of a multiple serving size options. It would also be advantageous if such a health tracking system enabled the use of serving sizes that are more easily understood and estimated by the user. Moreover, it would be advantageous if such a health tracking system could be used to more accurately track calorie consumption and nutritional data for the purpose of making healthy food and beverage choices.

### SUMMARY

In accordance with one exemplary embodiment of the disclosure, method of providing nutritional data to a user is disclosed. The method comprises: receiving a selection of a consumable item having a descriptor from a health tracking device; associating the selected consumable item with a consumable record in a database based on a comparison of the descriptor to a descriptive string for of the consumable record; obtaining from the consumable record a first serving size for the selected consumable item; calculating a second serving size for the selected consumable, the second serving size having a different unit of measurement than the first serving size; and providing the first serving size and the second serving size to the health tracking device.

Pursuant to another exemplary embodiment of the disclosure, a system for providing nutritional data to a user is disclosed. The system comprises: an interface configured to receive a selection of a consumable by the user via a health tracking device; a database configured to store a plurality of consumable records, each consumable record including: (i) a descriptive string for a corresponding consumable, and (ii) nutritional data regarding the corresponding consumable, the nutritional data at least including a serving size associated thereto; and a data processing system in communication with the health tracking device and the database, the data processing system being configured to (i) receive the selection of the consumable via the interface, (ii) associate the selected consumable with a consumable record in the database, (iii) set a first serving size for the selected consumable as the serving size included in the consumable record associated with the selected consumable, (iv) generate a second serving size for the selected consumable, the second serving size having a different unit of measurement than the first serving size, and (v) provide the first serving size and the second serving size to the health tracking device for display thereat to the user.

In accordance with yet another exemplary embodiment, a non-transient computer readable medium for providing nutritional data to a user is disclosed. The computer readable medium containing instructions to provide the nutritional data by: receiving a selection of a consumable from a health tracking device; associating the selected consumable with a consumable record in a database, the database including a plurality of consumable records, each consumable record including (i) a descriptive string for a corresponding consumable and (ii) nutritional data regarding the corresponding consumable, the nutritional data at least including a first serving size for the corresponding consumable; using the first serving size for the selected consumable to generate a plurality of second serving sizes for the selected consumable, the plurality of second serving sizes having a different unit of measurement than the first serving size; and providing the first serving size and the plurality of second serving sizes to the health tracking device for display thereat to the user.

The above described features and advantages, as well as others, will become more readily apparent to those of ordinary skill in the art by reference to the following detailed description and accompanying drawings. While it would be desirable to provide a health tracking system that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

The foregoing aspects and other features of a health and fitness tracking system are explained in the following description, taken in connection with the accompanying drawings.

FIG. 1 shows a health tracking system.

FIG. 2 shows a smartphone of the health tracking system of FIG. 1.

FIG. 3 shows a system server or data processing system of the health tracking system of FIG. 1.

FIG. 4 shows a method of maintaining a consumable records database of the system server of FIG. 1 for the purpose of providing nutritional data to a user.

FIG. 5 shows a graphical user interface for selecting a consumable using the smartphone of FIG. 1.

FIG. 6 shows a method of providing the list of search results to a health tracking device of FIG. 1.

FIG. 7 a method of providing nutritional data to a user of a health tracking device of FIG. 1.

FIG. 8 shows a graphical user interface for logging a consumable using the smartphone of FIG. 1.

FIG. 9 shows a graphical user interface for selecting a serving size using the smartphone of FIG. 1.

FIG. 10 shows a further graphical user interface for selecting a serving size using the smartphone of FIG. 1.

FIG. 11 shows a further graphical user interface for selecting a serving size using the smartphone of FIG. 1.

FIG. 12 shows a graphical user interface for selecting a serving size when creating a consumable record using the smartphone of FIG. 1.

FIG. 13 shows a graphical user interface for selecting a serving size when creating a recipe using the smartphone of FIG. 1.

FIG. 14 shows a method for generating additional serving sizes for consumable records in the consumable records database of FIG. 1 and FIG. 3.

FIG. 15 shows a method for estimating a relationship between units of measurement serving sizes of related consumable records in the consumable records database of FIG. 1 and FIG. 3.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

Disclosed embodiments include a method, system, and computer readable medium associated with health and fitness tracking devices in general, and in particular a device configured to collect and display nutritional information for a user.

In the following detailed description, reference is made to the accompanying drawings which form a part hereof wherein like numerals designate like parts throughout, and in which is shown, by way of illustration, embodiments that may be practiced. It is to be understood that other embodiments may be utilized and that structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

As used herein, the term “consumable” as refers to foods, beverages, dietary supplements, vitamin supplements, medication, and other items for consumption. As used herein, the term “consumable record” refers to a database record that relates to a particular consumable. Each consumable record comprises a plurality of data fields that relate to a particular consumable. In some embodiments, the consumable record includes a description field that includes data, such as a text string, that identifies or describes the particular consumable. In some embodiments, each consumable record includes fields for caloric content, macronutrients, micronutrients, serving size, and other nutrition and health information.

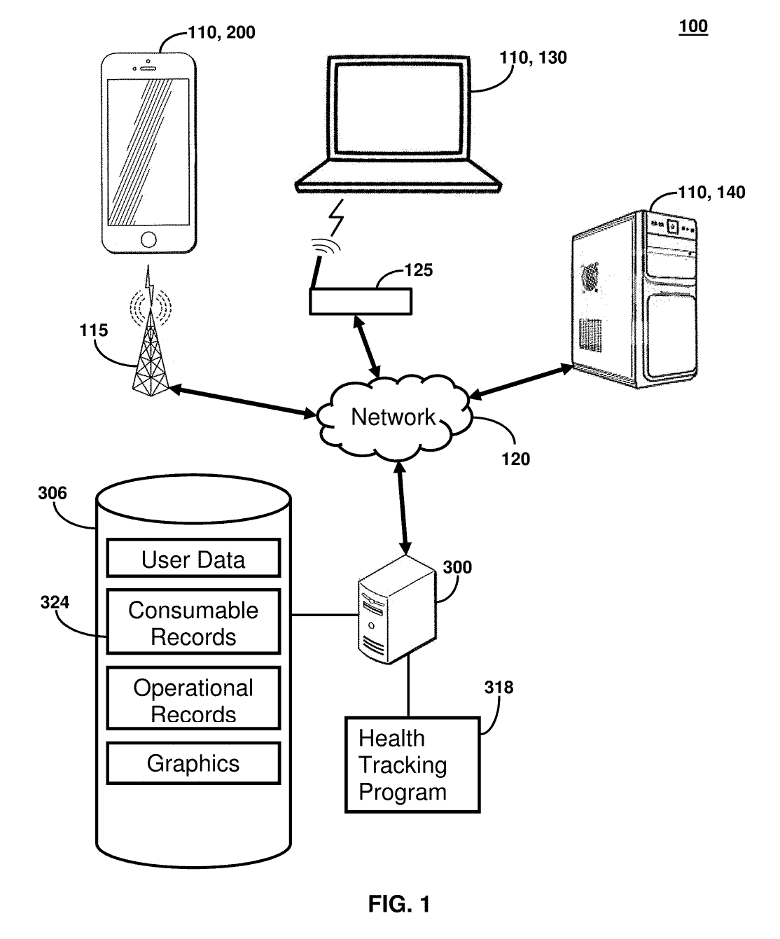

With reference to FIG. 1, an exemplary embodiment of a health tracking system 100 including smart serving sizes is shown. In the illustrated embodiment, the health tracking system 100 includes a plurality of health tracking devices 110 in communication with a system server 300 or other data processing system over a network 120 such as, e.g. the Internet.

The health and fitness tracking devices 110 (which may also be referred to herein as “health tracking devices”) comprise any computerized apparatus which includes a user interface such as e.g., a personal electronic device, a smartphone, laptop computer, a tablet computer, or other such device. In at least one embodiment, the user interface may comprise an LCD touch screen or the like, a mouse or other pointing device, a keyboard or other keypad, speakers, and a microphone, as will be recognized by those of ordinary skill in the art. The user interface provides the user with any of various health, fitness and activity related data such as food and nutritional consumption, calorie expenditure, heart rate, distance travelled, steps taken, etc. Health tracking devices 110 may use data collected from sensors associated to or in communication with the health tracking device 110, such as heart rate monitors, step counters, stair counters, global positioning system (“GPS”) tracking devices, as well as various other motion tracking and biometric monitoring devices; alternatively, or in addition, a user may manually enter health related data. Such sensors allow the user to easily track and automatically log activity information with the health tracking device. The term “health tracking system” as used herein refers to a health tracking system and/or health and fitness tracking system which includes a health tracking device 110 (which may or may not be used in association with a sensor device).

The server 300 comprises computerized device configured to run one or more software applications on a processor thereof. The server 300 of the present embodiment is further configured to receive a plurality of records relating to caloric content, nutritional content and serving size of consumables entered at the health tracking devices 110, other consumer devices, and/or provided from one or more manufacturing or distributing entities (e.g., consumable records 324). These are stored at a storage apparatus 306 of the processor 300. Alternatively, the server 300 may be in communication with a separate storage entity (not shown) for storage thereof.

The health tracking devices 110 are configured to communicate with the system server 300 to access and search the consumable records 324, display the consumable records, provide additional records, and enable the user to select individual ones of the displayed consumable records for the purposes of caloric and nutritional logging. In one embodiment, foregoing functions are performed via execution of one or more software applications at the server 300 in communication with one or more complementary software applications at the health tracking devices 110. For example, the health tracking program 318, running on the processor (of the sever 300) may be utilized to accomplish the foregoing, as explained in further detail below. A client-side software application for performing the same is also utilized (not shown). In a further embodiment, the health tracking program 318 is configured to incorporate smart serving size functionality as discussed elsewhere herein.

The smart serving size functionality is incorporated to assist the user in accurately logging the foods and beverages they consume by enabling the user to more easily determine an accurate size of their portions. Particularly, a food or beverage may have a serving size that is difficult for the user to relate to the size of the portion that he or she has consumed. For example, at a breakfast buffet, a user might eat a portion of scrambled eggs and a portion of hash browns. When the user attempts to log his or her breakfast using a health tracking device, the health tracking device might list the serving size for scrambled eggs as “2 eggs” and the serving size for hash browns as “3 ounces.” In order to log his or her meal, the user is required to estimate how many servings of “2 eggs” were in the portion of scrambled eggs and how many servings of “3 ounces” were in the portion of hash browns. The user may be able visually estimate that he or she has eaten about a cup of scrambled eggs and about a cup of hash browns, but is less certain about how many eggs were eaten and/or how many ounces of hash browns were eaten. As a result, the user is likely to under estimate or over estimate the size of his or her portions. The smart serving size functionality may further provide consistency and/or familiarity with respect to the units which are used to measure consumables that are presented to the user when logging food and beverages. For example, a first user may feel that it is easy to determine a weight of food consumed (e.g., 42 grams of broccoli), while another user may feel that it is easier to determine a volume of food consumed (e.g., 1 cup of broccoli) or a count of food consumed (e.g., 5 pieces/florets). These and other features will be discussed in further detail below.

Health Tracking Devices

As noted above, the health tracking devices 110 may be provided in any of various forms. Examples of a health tracking devices 110 configured for use with the health tracking system 100 include a smartphone 200, a laptop computer 130, and a desktop computer 140, as shown in FIG. 1. Accordingly, it will be recognized that the health tracking devices 110 may comprise portable electronic devices such as the smartphone 200 or the laptop computer 130, or stationary electronic devices such as the desktop computer 140. Other examples of health tracking devices include, handheld or tablet computers, smart watches, portable media players, other wearable devices, or any of various other health tracking devices configured to receive entry of consumables (not shown).

In one embodiment, data entered at one device 110 may be provided to other ones of the user's devices 110. For example, data entered at the smart phone 200 may be provided to the desktop computer 140 and/or the laptop computer 130 for storage thereat. Alternatively, the data may be stored at a single network storage apparatus (not shown) having a dedicated portion of storage for records relating to the user and accessible by all of the user's devices 110. As shown in FIG. 1, in order to connect to the network 120, the health tracking devices 110 are generally configured to utilize any of various wired or wireless communications components, infrastructures and systems, such as cell towers 115 of a mobile telephony network, wireless routers 125, Bluetooth®, near field communication (NFC), or physical cables.

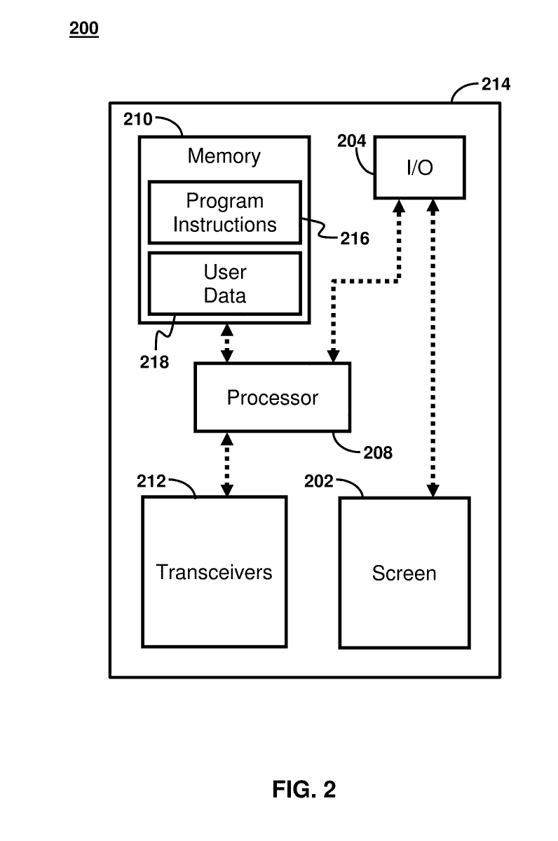

With reference now to FIG. 2, in at least one embodiment the health tracking device 110 is provided in the form of a smartphone 200. The smartphone 200 includes a display screen 202, an input/output (I/O) interface 204, a processor 208, a memory 210, and one or more transceivers 212. The smartphone 200 also includes a protective outer shell or housing 214 designed to retain and protect the electronic components positioned within the housing 214. The smartphone 200 also includes a battery (not shown) configured to power the display screen 202, processor 208, transceivers 212 and various other the electronic components within the smartphone 200.

The display screen 202 of the smartphone 200 may be an LED screen or any of various other screens appropriate for the personal electronic device. The I/O interface 204 of the smartphone 200 includes software and hardware configured to facilitate communications with the user. The I/O interface 204 is connected to the display screen 202 and is configured to visually display graphics, text, and other data to the user using the display screen 202. As will be recognized by those of ordinary skill in the art, the components of the health tracking device 110 may vary depending on the type of display device used. Alternative health tracking devices, such as the laptop 130 and the desktop 140, may include much of the same functionality and components as the smartphone 200 shown in FIG. 2, but may not include all the same functionality or components.

The processor 208 of the smartphone 200 may be any of various processors as will be recognized by those of ordinary skill in the art. The processor 208 is connected to the I/O interface 204, the memory 210, and the transceivers 212, and is configured to deliver data to and receive data from each of these components. The memory 210 is configured to store information, including data and instructions for execution by the processor 208. It will be recognized by those of ordinary skill in the art that a “processor” includes any hardware system, hardware mechanism or hardware component that processes data, signals or other information. A processor can include a system with a central processing unit, multiple processing units, dedicated circuitry for achieving functionality, or other systems.

The transceivers 212 may be any of various transceivers configured for communication with other electronic devices, including the ability to send communication signals and receive communication signals. The transceivers 212 may include different types of transceivers configured to communicate with different networks and systems. Such transceivers are well known and will be recognized by those of ordinary skill in the art.

In some embodiments, the transceivers 212 include a transceiver configured to allow the smartphone 200 to perform wireless communications with the cell towers 115 of the wireless telephony network, as will be recognized by those of ordinary skill in the art. The wireless telephony network may comprise any of several known or future network types. For example, the wireless telephony network may comprise commonly used cellular phone networks using CDMA, GSM or FDMA communication schemes, as well as various other current or future wireless telecommunications arrangements.

In some embodiments, the transceivers 212 include a transceiver configured to allow the smartphone 200 to communicate with any of various local area networks using WiFi, Bluetooth® or any of various other communications schemes.

In some embodiments, the memory 210 includes program instructions for a graphical user interface configured to provide a client-side health tracking application 216. The memory 210 may further be configured to store certain user data 218, such as e.g., user gender, height, weight, user identifier, password, etc. Additionally, health related data (e.g., data collected from one or more sensors and/or manually entered) may be stored. The processor 208 is configured to read the program instructions from the memory 210 and execute the program instructions to provide the health tracking application 216 to the user so for the purpose of performing health and fitness related tasks for the user, including displaying, modifying, and analyzing the user data 218.

In at least one embodiment, the user data 218 includes a plurality of consumable records which serves as a log of consumables that have been consumed by the user for the purpose of caloric and nutritional tracking. The client-side health tracking application 216 is configured to display consumable records and enable the user to select consumable records (from a plurality of records accessed via the network 120) that correspond to consumables that he or she has consumed for the purpose of logging the consumables. Further operations of the health tracking application are described in further detail below.

The memory 210 that retains the data and instructions may be of any type of device capable of storing information accessible by the processor, such as a memory card, ROM, RAM, write-capable memories, read-only memories, hard drives, discs, flash memory, or any of various other computer-readable medium serving as data storage devices as will be recognized by those of ordinary skill in the art. Portions of the system and methods described herein may be implemented in suitable software code that may reside within the memory as software or firmware. Alternatively, or in addition, the software (such as e.g., the client side health tracking program 216) may be downloaded from a network location, such as via the Internet.

A computer program product implementing an embodiment disclosed herein may therefore comprise one or more computer-readable storage media storing computer instructions translatable by a processor to provide an embodiment of a system or perform an embodiment of a method disclosed herein. Computer instructions may be provided by lines of code in any of various languages as will be recognized by those of ordinary skill in the art. A “non-transient computer-readable medium” may be any type of data storage medium that can store computer instructions, including, but not limited to the memory devices discussed above.

### System Server

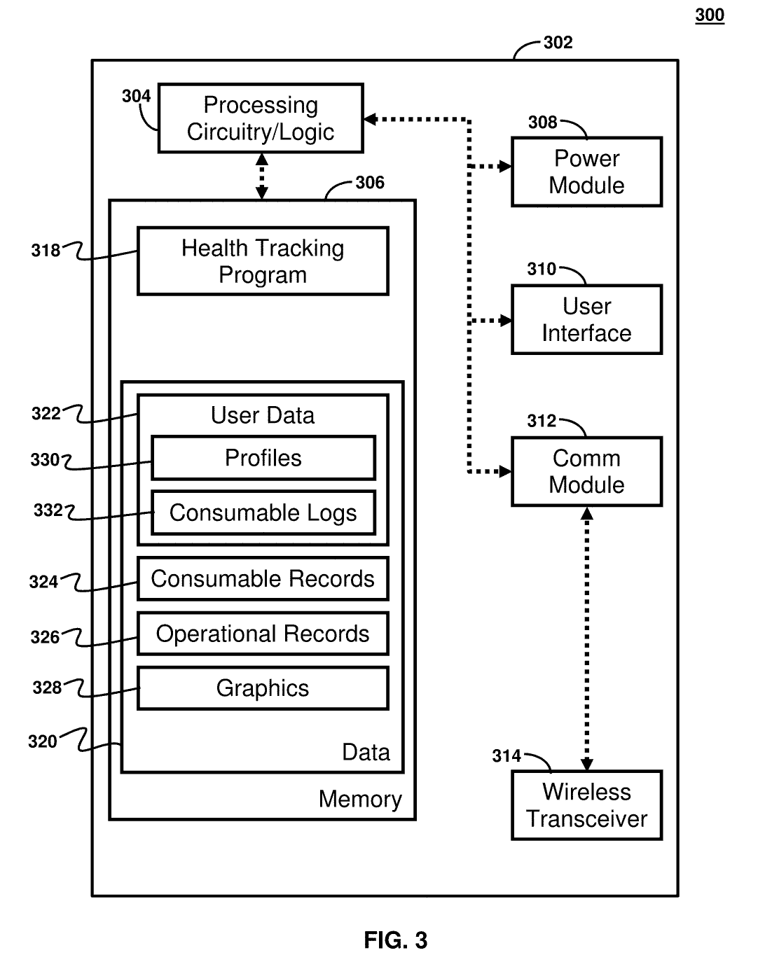

With reference now to FIG. 3, a block diagram of an exemplary embodiment of the system server 300 of FIG. 1 is shown. It should be appreciated that the embodiment of the system server 300 shown in FIG. 3 is only one exemplary embodiment of a system server 300. As such, the exemplary embodiment of the system server 300 of FIG. 3 is merely representative of any of various manners or configurations of system servers or other data processing systems that are operative in the manner set forth herein.

The system server 300 of FIG. 3 is typically provided in a housing, cabinet or the like 302 that is configured in a typical manner for a server or related computing device. The system server 300 includes processing circuitry/logic 304, memory 306, a power module 308, a user interface 310, a network communications module 312, and a transceiver 314.

The processing circuitry/logic 304 is operative, configured and/or adapted to operate the system server 300 including the features, functionality, characteristics and/or the like as described herein. To this end, the processing circuitry/logic 304 is operably connected to the memory 306, the power module 308, the user interface 310, the network communications module 312, and the wireless transceiver 314. The memory 306 is configured to store a network-side health tracking application 318 for execution by the processing circuitry/logic 304, as well as data 320 for use by at least the health tracking program 318. The data 320 includes user data 322, a consumable records database 324, operational records 326, and graphics 328. As discussed in greater detail below, the health tracking application 318 is further configured to include smart serving size functionality.

With continued reference to FIG. 3, the power module 308 of the system server 300 is operative, adapted and/or configured to supply appropriate electricity to the system server 300 (i.e., including the various components of the system server 300). The power module 308 may operate on standard 120 volt AC electricity, but may alternatively operate on other AC voltages or include DC power supplied by a battery or batteries.

The network communication module 312 of the system server 300 provides an interface that allows for communication with any of various devices using various means. In particular, the network communications module 312 includes a local area network port that allows for communication with any of various local computers housed in the same or nearby facility. In some embodiments, the network communications module 312 further includes a wide area network port that allows for communications with remote computers over the Internet (e.g., network 120 of FIG. 1). Alternatively, the system server 300 communicates with the network 120 via a modem and/or router of the local area network. In one embodiment, the network communications module is equipped with a Wi-Fi transceiver 314 or other wireless communications device. Accordingly, it will be appreciated that communications with the system server 300 may occur via wired communications or via the wireless communications. Communications may be accomplished using any of various known communications protocols. In the embodiment of FIG. 3, the wireless transceiver 314 is identified as a Wi-Fi transceiver, but it will be recognized that the wireless transceiver could use a different communications protocol.

The system server 300 may be accessed locally by an authorized user (i.e., an administrator or operator). To facilitate local access, the system server 300 includes an interactive user interface 310. Via the user interface 310, the health tracking app 318, and may collect data from and store data to the memory 306. In at least one embodiment, the user interface 310 may suitably include an LCD touch screen or the like, a mouse or other pointing device, a keyboard or other keypad, speakers, and a microphone, as will be recognized by those of ordinary skill in the art. Accordingly, the user interface 310 is configured to provide an administrator or other authorized user with access to the memory 306 and allow the authorized user to amend, manipulate and display information contained within the memory.

As mentioned above, the memory 306 includes various programs and other instructions that may be executed by the processor circuitry/logic 304. In particular, the memory 306 of the system server 300 of FIG. 3 includes the health tracking program 318 (which may also be referred to herein as a “health tracking application” or a “health tracking app”). The health tracking program 318 is configured to cause the system server 300 to enable a user to obtain nutritional data related to any of various consumables. Execution of the health tracking application 318 by the processor circuitry/logic 304 results in signals being sent to and received from the user interface 310 and the communications module 312 (to a user device such as a health tracking device 110), in order to allow the user receive and update the information in the consumable records database 324. Various aspects of the consumable records database 324 are explained in further detail below. The health tracking app 318 is configured to provide various graphical views and screen arrangements to be displayed to a user on a health tracking device 110.

The user data 322 includes at least user profiles 330 and corresponding consumable logs 332. The user profiles 330 include a profile data for each user of the health tracking system 100. Each user profile includes demographic information for the users such as name, age, gender, height, weight, performance level (e.g., beginner, intermediate, professional, etc.) or other information for the user. In at least one embodiment, the consumable logs 332 include a consumable diary/log for each user. The consumable diary/log allows the user to track consumables that are consumed by the user over a period of days and any nutritional data associated with the food consumed. For example, the consumable diary/log may allow the user to enter particular consumable that is consumed by the user and keep track of the associated calories, sugar, carbohydrates, protein, or any of various other nutritional data associated with the consumables entered by the user in the consumable diary/log. In some embodiments, the user data 322 further includes various activity and fitness data collected by sensors (not shown) associated with the health tracking devices 110.

The consumable records database 324 comprises a plurality of consumable records. As discussed above, the term “consumable record” refers to a database record that relates to a particular consumable. Each consumable record comprises a plurality of data fields that related to a particular consumable. Consumable records are editable by users or may be created by users within the consumable records database 324 without the need for special authorization or privileges. In at least one embodiment, each of the consumable records includes a number of fields including, for example, a name for the consumable, summary information about the consumable, and detailed nutritional information about the consumable. Detailed information about a consumable may include one or more of serving size, calories, ingredients, or any other nutritional information about the consumable. For example, the nutritional information may include information that may be provided on USDA food labels or state-regulated food labels (e.g., vitamin and mineral content, fat content, cholesterol content, protein content, sugar content, carbohydrate content, fiber content, organic contents, etc.). The summary information about the consumable may include some subset of the more detailed information about the consumable. For example, the summary information about the consumable may only include serving size and calorie information. The various fields of each consumable record can be populated by data from any user or third party data providers. Therefore, it will be recognized that in at least some embodiments, consumable records in the consumable records database 324 may have been entered by any of various sources including the administrator of the health tracking system 100, commercial food providers (e.g., restaurant owners), and users of the health tracking system 100.

The operational records 326 include current and historical data stored by the system server 300 in association with operation of the system server 300, execution of the health tracking app 318, and manipulation of data 320 within the memory 306. For example, the operational records 326 may include information concerning amendments made to any of various consumable records 324. The operational records 326 may also include other information related to the control and operation of the system server 300, including statistical, logging, licensing, and historical information.

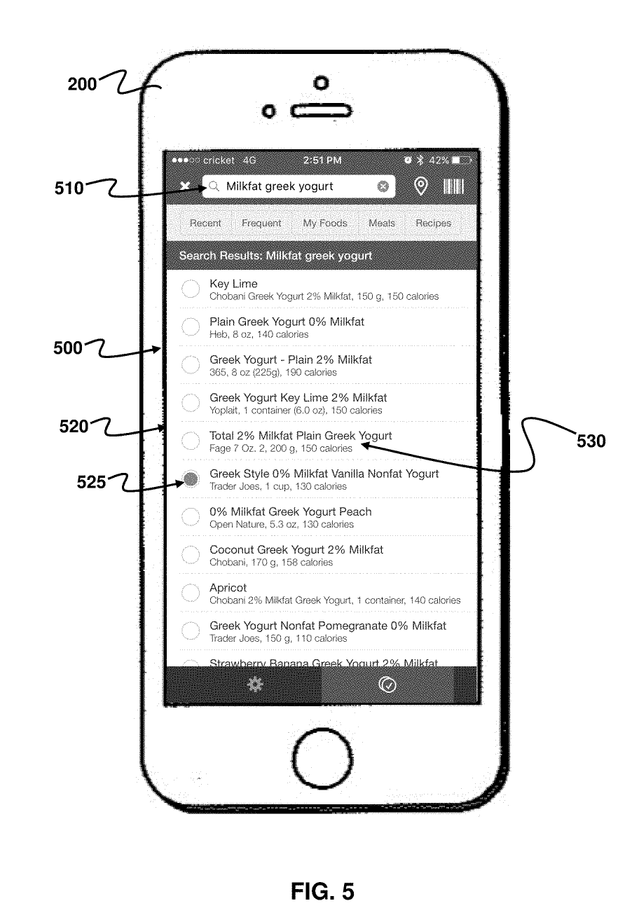

In one embodiment, graphical views 328 are provided at the server 300 which are pushed to the health tracking device 110 for display thereat of various screen arrangements, as shown in FIG. 1. Examples of such screens for display on a health tracking device 110 are provided in FIGS. 5 and 8-13, discussed in further detail below.

In another alternative, while the system server 300 has been explained in the foregoing embodiment as housing the health tracking program 318 and the various records and databases in the memory 306, it will be recognized that these components may be retained in other one or more remote locations in communication with the health tracking system 100. For example, in at least one embodiment, the consumable records 324 may be data retained by a database separate from the system server 300. Alternatively, the consumable records 324 or certain fields of the consumable records 324 are received from a third party database. In such embodiments, the health tracking app may utilize any number of APIs to access the data in the third party databases and incorporate such information for use in the health tracking app 318. Accordingly, it will be recognized that the description of the system server 300 of FIG. 3 is but one exemplary embodiment of a data processing system that may be utilized by the health tracking system 100.

### Consumable Records Data Entry

Methods for operating the health tracking system 100 are described below. In the description of the methods, statements that a method is performing some task or function refers to a controller or general purpose processor executing programmed instructions stored in non-transitory computer readable storage media operatively connected to the controller or processor to manipulate data or to operate one or more components in the health tracking system 100 to perform the task or function. Particularly, the processor circuitry/logic 304 of the system server 300 and/or the processor 208 of the smartphone 200 can above can be such a controller or processor. Alternatively, the controller can be implemented with more than one processor and associated circuitry and components, each of which is configured to form one or more tasks or functions described herein. Additionally, the steps of the methods may be performed in any feasible chronological order, regardless of the order shown in the figures or the order in which the steps are described.

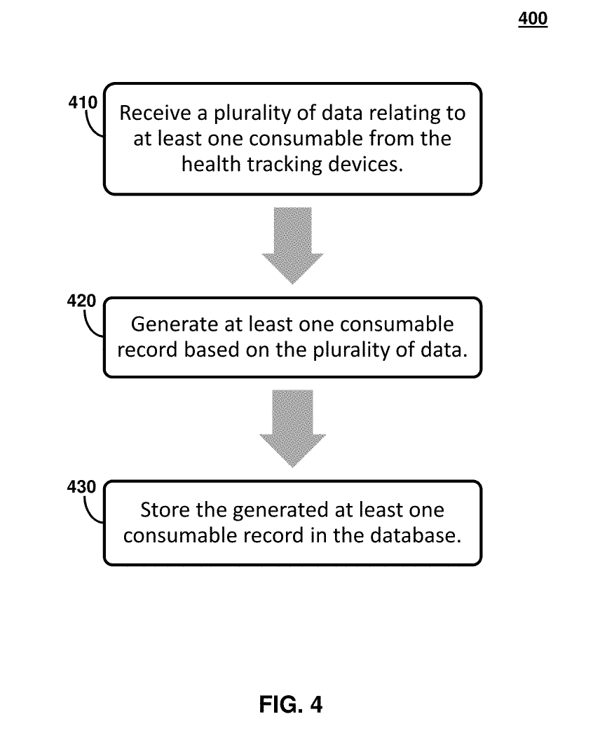

FIG. 4 shows a method 400 of maintaining a consumable records database for the purpose of providing nutritional data to a user. The method 400 begins with step 410 where a plurality of data relating to at least one consumable are received from the health tracking devices. The plurality of data including a descriptive string and a serving size for the respective at least one consumable in one embodiment. Particularly, the processing circuitry/logic 304 of system server 300 is configured to receive data regarding a consumable from a health tracking device 110 via the network communication module 312 or the wireless transceiver 314. The data comprise information for populating the fields of a consumable record, such as descriptive and nutritional information. In particular, the data may include at least a serving size for the consumable and a descriptive string (i.e. a name) for the consumable. However, in other embodiments, the data include detailed nutritional information such as caloric content, macronutrient content, and micronutrient content, as discussed above. Additionally, the system server 300 may receive some or all of the data from a third party data source, as discussed above.

Next, the method 400 includes a step of generating consumable records based on the plurality of data (block 420). Particularly, the processing circuitry/logic 304 is configured to execute program instructions in the memory 306 to compile the received data into a consumable record. The processing circuitry/logic 304 is configured to parse the received data and allocate values from the data to appropriate fields in the consumable record. Finally, the method 400 includes a step of storing the generated at least one consumable record in the database (block 430). Particularly, the processing circuitry/logic 304 is configured to write the consumable record to the memory 306 and add it to the consumable record database 324.

With reference to FIG. 5, an exemplary user interface for selecting a consumable using the smartphone 200 is briefly described to further aid in the understanding of the disclosure. Particularly, when a user opens the health tracking app using the program instructions 216 of the smartphone 200, he or she is provided with the illustrated graphical user interface (GUI) 500 that is displayed on the screen 202. (Alternatively, the GUI may be displayed on any computerized device associated with the user.) If the user desires to log a consumable, then he or she may type a search query (e.g. “Milkfat greek yogurt”, as shown) into search box 510. A list of consumables (e.g. “Key Lime”, “Plain Greek Yogurt 0% Milkfat”, etc., as shown) are provided as a list of search results 520 from the system server 300 and displayed on the GUI 500. Each entry of the search results list 520 is labeled with a descripting string (i.e. a description and/or brand name) from the associated consumable record.

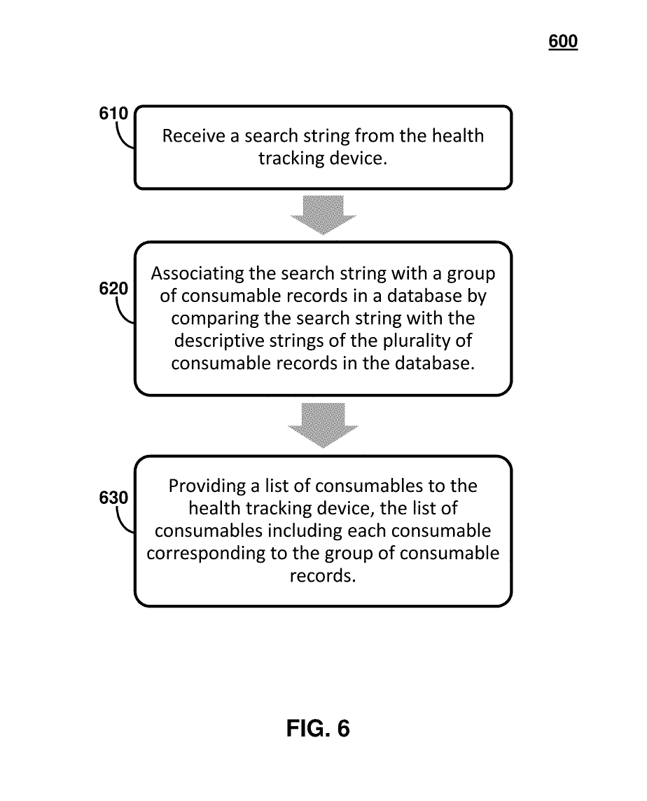

FIG. 6 shows a method 600 of providing the list of search results 520 of FIG. 5 to the smartphone 200 (or other computerized user device). The method 600 begins at step 610 where a search string is received from the health tracking device. Particularly, the processing circuitry/logic 304 of system server 300 is configured to receive data comprising a search string (e.g. “Milkfat greek yogurt”, as shown in FIG. 5) that was typed in the search box 510 (see FIG. 5) via e.g., a smartphone 200 using the network communication module 312 and/or the wireless transceiver 314.

Next, the method 600 includes a step of associating the search string with a group of consumable records in a database by comparing the search string with the descriptive strings of the plurality of consumable records in the database (block 620). Particularly, the processing circuitry/logic 304 is configured to execute program instructions in the memory 306 to perform a search of the consumable records database 324 with reference to the received search string. In one embodiment, the processing circuitry/logic 304 is configured to compare the search string with the descriptive field of each of the consumable records in the database 324. Based on the comparison, the processing circuitry/logic 304 is configured to determine a group of consumable records in the database 324 that are associated with the search string based. In one embodiment, the group is formed based on a similarity between the search string and the descriptive field of the consumable records.

Finally, the method 600 includes a step of providing a list of consumables to the health tracking device, the list of consumables including each consumable corresponding to the group of consumable records (block 630). Particularly, the processing circuitry/logic 304 is configured to execute program instructions in the memory 306 to compile a list of consumables (i.e. search results) that correspond to the group of consumable records that result from the search of the consumable records database 324 within a given threshold of similarity. The processing circuitry/logic 304 is configured to transmit data comprising the list of consumable to the smartphone 200 via the network communication module 312 or the wireless transceiver 314. In one embodiment, the transmitted data include the entire consumable record that corresponds to each consumable of the list of consumables. Alternatively, the transmitted data may merely include the descriptive field or name for each consumable record. In one embodiment, the data may further include a ranking of the list of consumable based on a relevance to the search string.

Referring back again to FIG. 5, an example of a list of search results 520 that may be displayed on the screen 202 of the smartphone 200 at the completion of the method of FIG. 6 is given. The user may review the list of search results 520 and select and one of the records in the list of consumables via a radio button 525 as a selected entry 530 corresponding to a consumable that he or she would like to add to his or her consumable log for the purpose of caloric and nutritional tracking. The selected entry 530 is then sent to the system server 300 as a selected consumable from the health tracking device. Thus, in the example of FIG. 5, if the user selects entry 530 (i.e., “Total 2% Milkfat Plain Greek Yogurt”), the health tracking device 200 sends this entry 530 to the system server 300 for storage of a log of selected entries thereat. The user interface may subsequently be updated to indicate the selection e.g., by decreasing a calories/nutrients remaining and/or increasing calories/nutrients consumed with respect to a running total for the meal/day/week/month, etc.

While a particular embodiment of the search results 520 have been shown in the example of FIG. 5 on a smartphone 200, it will be understood to those having ordinary skill in the art that similar interfaces with a user could be implemented on the laptop 130 or the desktop 140 using software or via a webpage in a web browser. Additionally, it will be understood that the particular design of the GUI 500 may vary from the specific embodiment shown.

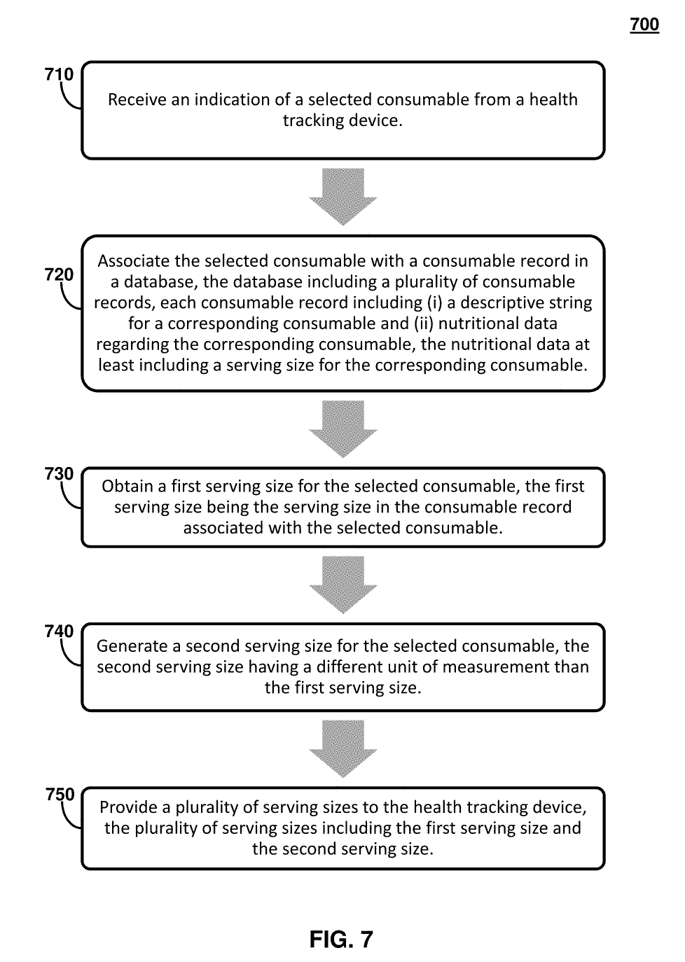

With reference now to FIG. 7, a method is described for providing nutritional data to a user after the user has sent a selected consumable to the server 300 (as noted above in association with FIGS. 5 and 6). More particularly, a method 700 for providing the user with a plurality of smart serving size options is shown. The method 700 begins with a step of receiving an indication of a selected consumable from a health tracking device (block 710). Particularly, with respect to the embodiments described in detail herein, the processing circuitry/logic 304 of system server 300 is configured to receive an indication of a selected consumable from one of the health tracking devices 110 via the interface of the network communication module 312 or the wireless transceiver 314. More particularly, in one embodiment, a signal is received at the network communications module 312 or the wireless transceiver 314 from one of the health tracking devices 110, including the smartphone 200, the laptop 130, the desktop 140, and any other comparable device. The signal comprises data that indicate that a consumable or consumable record has been selected by a user of the health tracking device 110.

With continued reference to FIG. 7, the method 700 includes a step (as noted in block 720) of associating the selected consumable with a consumable record in a database, the database including a plurality of consumable records, each consumable record including (i) a descriptive string for a corresponding consumable and (ii) nutritional data regarding the corresponding consumable, the nutritional data at least including a serving size for the corresponding consumable. Particularly, the processing circuitry/logic 304 is configured to execute program instructions in the memory 306 to determine which of the consumable records in the database 324 is associated with and/or corresponds with the consumable or consumable record has been selected by a user of the health tracking device 110. As discussed above, each consumable record at least includes a serving size for the corresponding consumable and a descriptive string (i.e. a name) for the corresponding consumable. Additionally, each record may also include detailed nutritional information such as caloric content, macronutrient content, and micronutrient content.

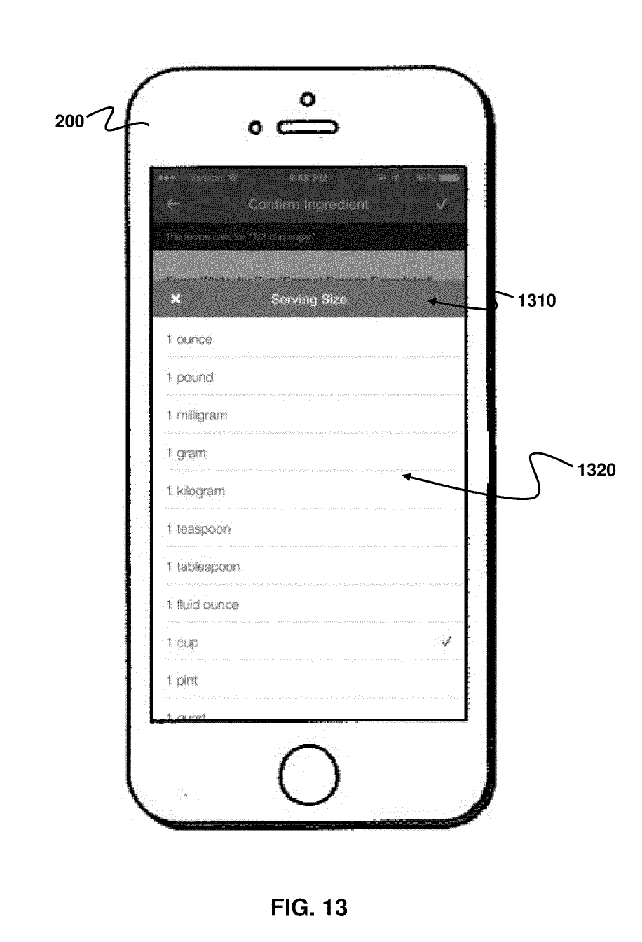

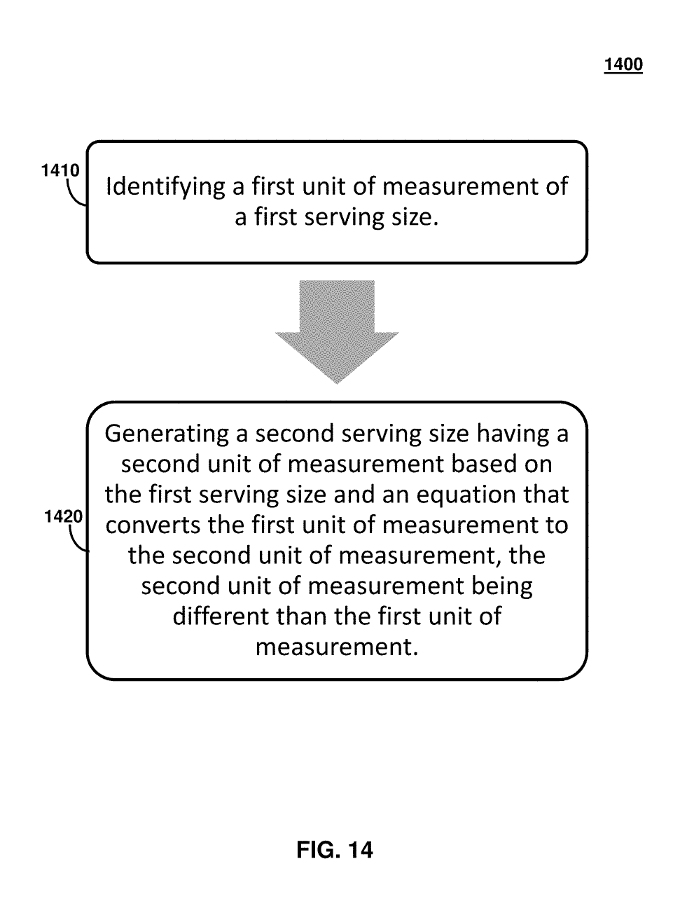

With continued reference to FIG. 7, the method 700 further includes a step (as noted in block 730) of obtaining a first serving size for the selected consumable, the first serving size being the serving size in the consumable record associated with the selected consumable. Particularly, the processing circuitry/logic 304 is configured to execute program instructions in the memory 306 to read a default serving size from the consumable record associated with the selected consumable. The default serving size is generally a serving size that was entered by a user when the consumable record was created. Next, the method 700 includes a step (as noted in block 740) of generating a second serving size for the selected consumable, the second serving size having a different unit of measurement than the first serving size. Particularly, the processing circuitry/logic 304 is configured to execute program instructions in the memory 306 to generate at least one additional serving size that has a different unit of measurement than the default serving size. Various methods of generating the at least one additional serving size will be discussed in more detail below with reference to FIGS. 13 and 14.

It should be noted that the steps of blocks 730 and 740 are not necessarily performed chronologically after the steps of blocks 710 and 720. In many embodiments, these steps are performed immediately after each consumable record is generated, for example by the method 400 discussed above. Particularly, in one embodiment, after a consumable record is initially generated, the processing circuitry/logic 304 is configured to execute program instructions in the memory 306 to generate additional serving sizes according the step of block 740. The additional serving sizes may be stored in an additional field of the consumable record in the database 324. In such an embodiment, the additional serving sizes for the selected consumable are actually generated before receiving an indication of a selected consumable (block 710) and associating it with a consumable record in the database 324 (block 720). In some embodiments, the processing circuitry/logic 304 is configured to perform the step of block 740 periodically to update the serving size options for each consumable record in the database 324. In one embodiment, the processing circuitry/logic 304 is configured to perform the step of block 740 with respect to a consumable record associated with a selected consumable in response the consumable being selected.

With continued reference to FIG. 7, the method 700 further includes a step (as noted in block 750) of providing a plurality of serving sizes to the health tracking device, the plurality of serving sizes including the first serving size and the second serving size. Particularly, the processing circuitry/logic 304 is configured to execute program instructions in the memory 306 to transmit a plurality of serving sizes for the selected consumable to the health tracking device 110 via the network communication module 312 or the wireless transceiver 314. In some embodiments in which the additional generated serving sizes are stored as a part of the consumable record, the processing circuitry/logic 304 is configured to transmit the plurality of serving sizes by sending the corresponding consumable record in its entirety to the health tracking device 110.

It should be noted that that the step of block 750 is not necessarily performed chronologically after the steps corresponding to blocks 710 and 720. Particularly, in some embodiments, the additional serving sizes are generated immediately after the consumable record is generated and are stored in the consumable record. Accordingly, the plurality of serving sizes is provided whenever the consumable record is actually transmitted to the health tracking device 110. In another alternative, the consumable records are transmitted to the health tracking device 110 in response to a search query, as described with respect to the method 600, for example. In such an embodiment, the plurality of serving sizes are actually provided to the health tracking device 110 before receiving an indication of a selected consumable (block 710). In another embodiment, consumable records are only transmitted in their entirety after receiving an indication of a selected consumable (710). Accordingly, in such embodiments, the plurality of serving sizes is provided to the health tracking device 110 at that time.

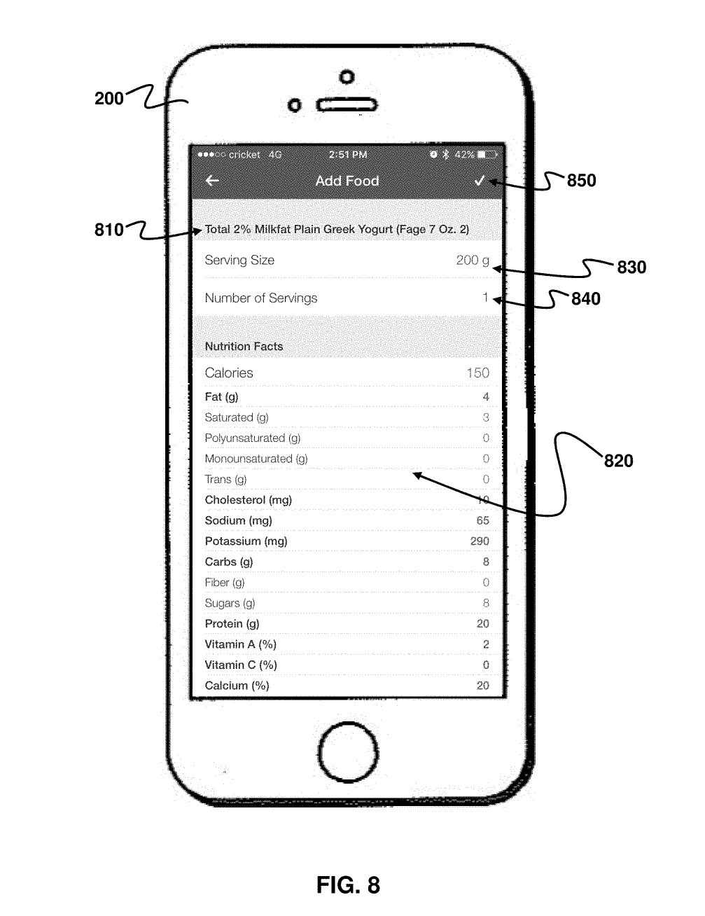

With reference to FIG. 8-11, exemplary user interfaces for use in logging a consumable (via selection of a consumable record) and selecting a serving size such as via the smartphone 200 are provided to further aid in the understanding of the disclosure. In FIG. 8, assume that the user selected entry the “Total 2% Milkfat Plain Greek Yogurt” entry from the search results list 520 of FIG. 5, and this selected entry 530 corresponds to a consumable that he or she would like to add to his or her consumable log for the purpose of caloric and nutritional tracking. As shown in FIG. 8, once entry 530 is selected by the user, the GUI shows information from the consumable record that corresponds to the selected entry 530. The GUI shows the descriptive string 810 of the consumable record, which describes the associated consumable (i.e., descriptive string 810 corresponds to the selected entry 530). The GUI further shows nutritional information 820 including caloric content, macronutrient content, and micronutrient content for the associated consumable. The GUI also provides a plurality of selectable options including at least a “serving size” option 830 and a “number of servings” option 840.

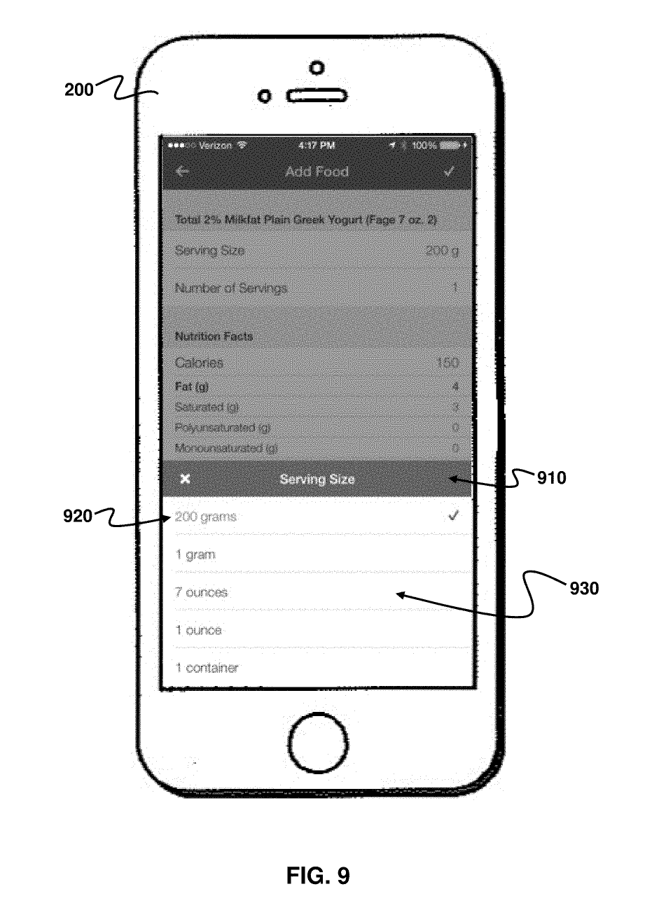

When the “serving size” option 830 (see FIG. 8) is selected by the user, the user is presented with various serving size options. In particular, as shown in FIG. 9, the GUI shows a menu 910 that provides a list of serving size options. The serving size options correspond to the plurality of serving sizes (e.g. “200 grams”, “1 gram”, “7 ounces”, “1 ounce”, “1 container”, as shown in FIG. 9) that were provided from the system server 300 and, in some embodiments, which are stored in the consumable record. The menu 910 lists at least a default serving size 920 as the first option on the menu 910, which was added at the creation of the consumable record. The menu 910 also lists at least one additional serving size 930, which was generated by the system server 300 as an option of a different serving size that may be used to log the consumable. The user selects one of the serving size options to use for the purpose of logging the consumable. In one embodiment, the selection occurs via touch screen or click selection.

Returning to the FIG. 8, after the user has made appropriate selections for the “serving size” option 830, the user may then adjust the “number of servings” option 840. Serving size selection will be discussed in greater detail below. It is appreciated that in one embodiment, the default number of servings comprises one serving. Alternatively, the number of servings may default to the total number of servings in a given container (e.g., 1 bag of chips may comprise 2.5 servings). Adjustment to the number of servings may be made by the user when the default number does not correlate to the actual number consumed. The user logs the food (or other consumable) by selecting the “Add Food” option 850.

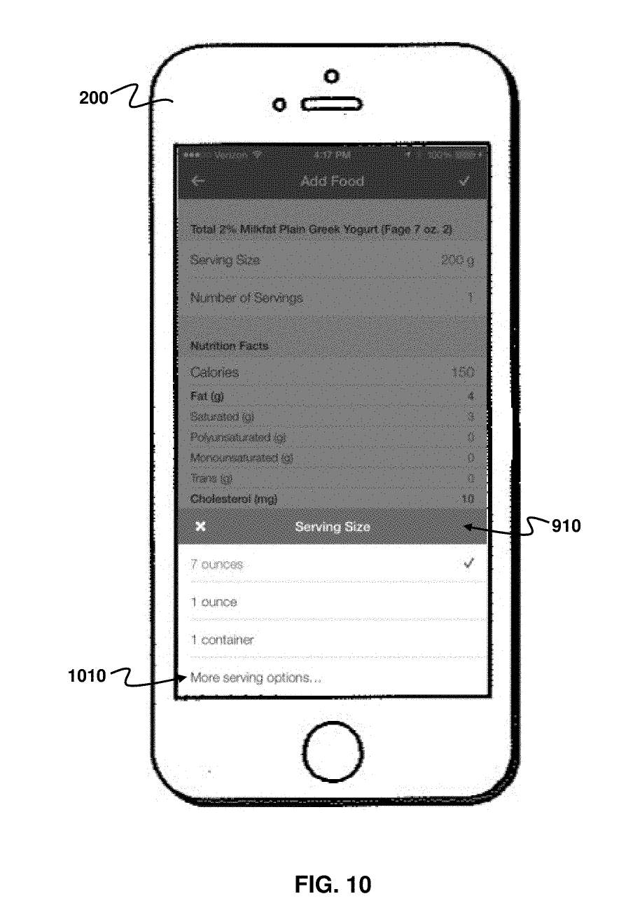

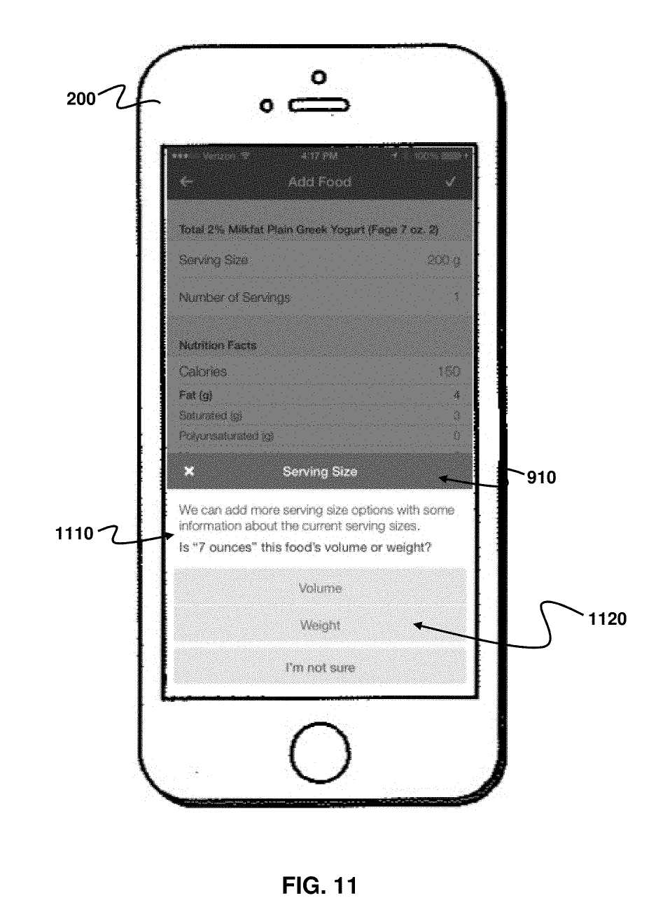

In the embodiment of FIG. 10, the menu 910 lists a “More serving options” entry 1010. When the user selects the “More serving options” entry, the GUI displays an information dialog 1110, as shown in FIG. 11. The information dialog 1110 requests information from the user in order to generate additional serving sizes or to evaluate the accuracy current serving sizes. For example, in one embodiment, the dialog 1110 may ask the user if a serving size in “ounces” is meant to be a weight or a volume, thereby enabling additional serving sizes to be generated and improving the accuracy of the already generated serving size in ounces. Various options 1120 are provided for selection by the user in response to the query. In the embodiment shown, the serving size of “7 ounces” was parsed from the descriptive title of the consumable record, but the system server 300 does not know if the serving size is ounces (weight) or fluid ounces (volume) (e.g., 16 ounces of milk (volume) is that is not the same as 16 ounces of beef (weight)). The dialog 1110 thereby enables greater understand of the serving size and may allow further serving size options to be generated.

In at least one embodiment, all consumable records in the database are categorized based on the descriptive string for the consumable and the serving size options presented to the user are based at least in part on the categorization. For example, if a particular consumable is categorized as a “beverage”, the system 100 anticipates that the serving size will be in volume (e.g., fluid ounces, cups, milliliters, etc.), and the volume options are the first options presented to the user when selecting a serving size during the consumable logging process. If another consumable is categorized as a solid food (e.g., fruit, vegetable, bread, cereal, meat, etc.), the system 100 anticipates that the serving size will be in weight (e.g., ounces, grams, etc.), and the weight options are the first options presented to the user when selecting a serving size during the consumable logging process.

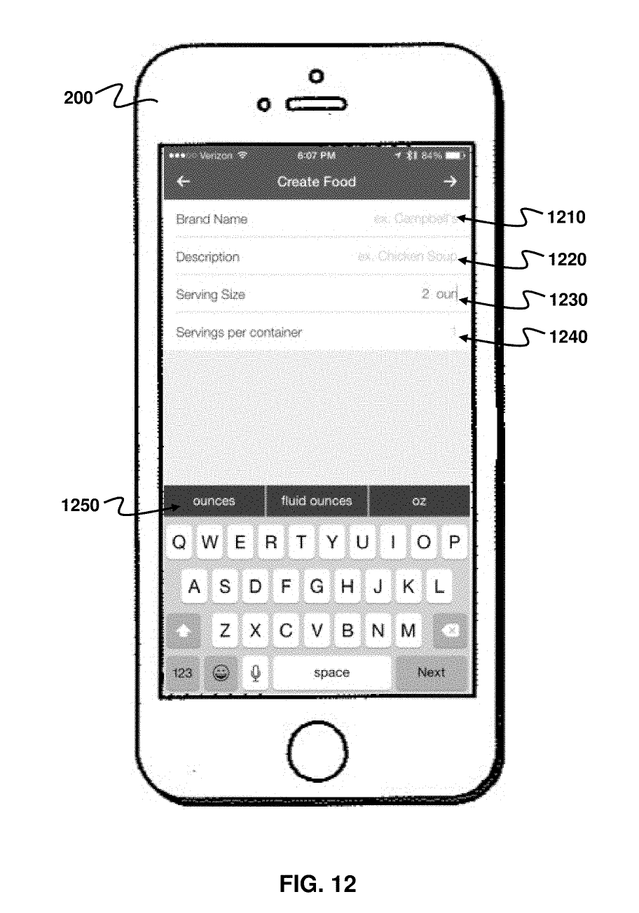

With reference to FIG. 12, an exemplary interface for creating a consumable record using the smartphone 200 is briefly described to further aid in the understanding of the disclosure. Particularly, when a user uses the health tracking app of the program instructions 216, the GUI enables the user to create a new consumable record that is added to the consumable record database 324 of the system server 300. The GUI provides a plurality of selectable options and/or text boxes including “Brand Name” 1210 (e.g. Campbell's®, Kraft®, Digiorno®, etc.), “Description” 1220 (e.g. Chicken Soup, Mac & Cheese, Stuffed Crust Pizza, etc.), “Serving Size” 1230, and “Servings per container” 1240. The user may enter text or numbers into these fields to create a consumable record. When the user enters text into the “Serving Size” text box 1230, the GUI displays suggested serving sizes and/or serving size units in a line 1250 (e.g. “ounces”, “fluid ounces”, “oz”, etc. are suggested because the user has started to spell “ounces” at the serving size entry 1230). Additionally, as noted above, if the user has already entered a consumable in the “Description” line 1220, the serving size options presented in line 1250 may depend at least in part on a categorization of the consumable (e.g., “fluid ounces” may be presented for chicken soup, and “ounces” may be presented for “chicken breast”). On a following screen of the GUI 500 (not shown), the user may enter additional information such as detailed nutritional information before submitting the consumable record to the system server 300 for entry in the consumable record database 324.

Referring now to FIG. 13, an exemplary interface for creating a recipe using the smartphone 200 is briefly described to further aid in the understanding of the disclosure. Particularly, when a user uses the health tracking app of the program instructions 216, the GUI enables the user to create a recipe. In this context, a recipe comprises one or more consumable records corresponding to one or more ingredients that are combined for easy logging when cooking meals at home. When adding ingredients to a recipe, the GUI provides a menu 1310 that shows a list of units of measurement 1320 that can be used for a serving size that can be used for a particular ingredient. In the example of FIG. 13, the menu 1310 lists possible units of measurement including “1 ounce”, “1 pound”, “1 milligram”, etc. Again, the order of serving sizes presented to the user may depend at least in part on a food categorization for the consumable being entered (e.g., beverage, fruit, vegetable, eggs, rice, pasta, poultry, etc.). Such categorizations may be entered by the users and/or preloaded at the server.

### Methods for Generating Smart Serving Options

With reference to FIG. 14, a method 1400 for generating additional serving sizes for consumable records is disclosed. In particularly, the method 1400 is an elaboration of the step of block 740 of the method 700. The method 1400 begins with a step of identifying a first unit of measurement of a first serving size (block 1410). Particularly, the processing circuitry/logic 304 of the system server 300 is configured to execute program instructions in the memory 306 to identify in a unit of measurement of the default serving size stored in the consumable record associated with the selected consumable. In one embodiment, this default serving size comprises a size which was entered by the creator of the consumable record.

Next, the method 1400 includes a step of generating a second serving size having a second unit of measurement based on the first serving size and an equation that converts the first unit of measurement to the second unit of measurement, the second unit of measurement being different than the first unit of measurement (block 1420). Particularly, the processing circuitry/logic 304 of the system server 300 is configured to execute program instructions in the memory 306 to generate an additional serving size based on the default serving size via an equation that relates the unit of measurement of the default serving size to a second unit of measurement. In one embodiment, the equation is simply the predefined and known conversion between two standard units of measurement. For example, if the selected consumable record is a banana having a serving size of “126 grams”, the processing circuitry/logic 304 generates an additional serving size of “4.44 oz.” using the known conversion ratio between grams and ounces (i.e. 1 ounce=28.35 grams). Accordingly, the system 100 is configured to provide multiple serving sizes for a single consumable, each of the multiple serving sizes based on an equation that provides a standard conversion between units. Thus, users may choose to log consumable items using the units they are most comfortable with (e.g., grams, ounces, etc.).

While FIG. 14 discloses presentation of different serving sizes based on a known relationship between two standard units of measurement (e.g., a known standard exists for converting ounces to grams, and vice-versa); in other embodiments, the equation is based on a learned relationship between a standard unit of measurement and a non-standard unit of measurement (e.g., 1 banana is a non-standard unit of measurement because each banana has a different size). Particularly, in some embodiments, the processing circuitry/logic 304 is configured to execute program instructions in the memory 306 to estimate a relationship between a standard unit of measurement and a non-standard unit of measurement based on at least two consumable records in the consumable record database 324. The processing circuitry/logic 304 is configured to determine the equation based the estimated relationship between the standard unit of measurement and the non-standard unit of measurement.

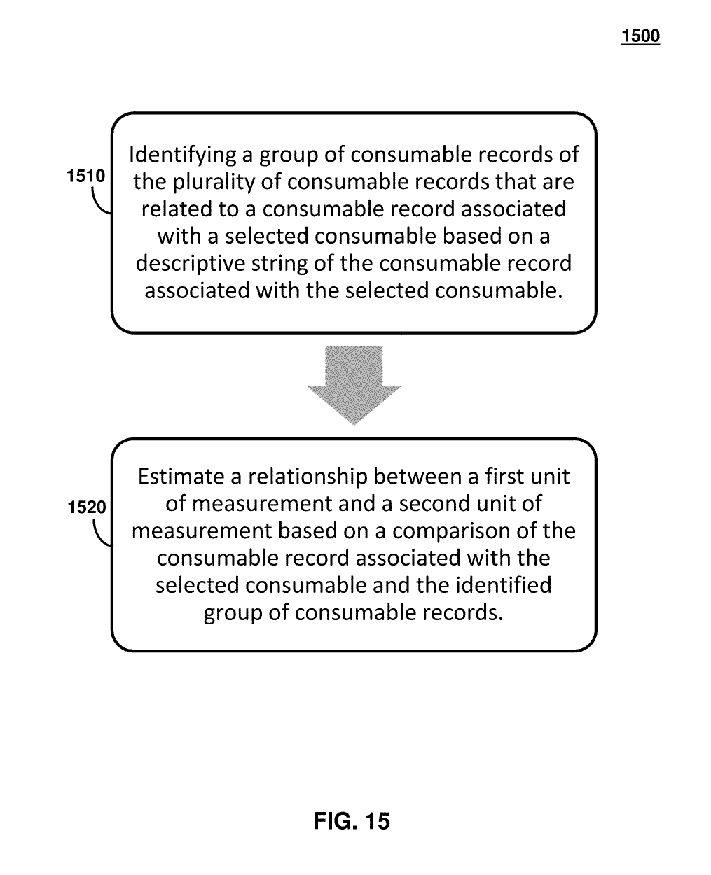

With reference to FIG. 15, a method 1500 for estimating the relationship between units of measurement is disclosed. The method 1500 begins with a step of identifying a group of consumable records of the plurality of consumable records that are related to a consumable record associated with a selected consumable based on a descriptive string of the consumable record associated with the selected consumable (block 1510). Particularly, the processing circuitry/logic 304 is configured to execute program instructions in the memory 306 to perform a clustering algorithm and identify a cluster (or group) of consumable records in the consumable record database 324 that are related to the same consumable. In one embodiment, the processing circuitry/logic 304 is configured to identify the cluster of related consumable records based on the descriptive string of each consumable record.

Next, the method 1500 includes a step of estimating a relationship between a first unit of measurement and a second unit of measurement based on a comparison of the consumable record associated with the selected consumable and the identified group of consumable records (block 1520). Particularly, the processing circuitry/logic 304 is configured to estimate the relationship between the default unit of measurement and an additional unit of measurement based on a comparison of the consumable item record associated with the selected consumable item and the identified cluster of consumable item records.

For example, if the selected consumable record is banana having a serving size of “1 banana” (a non-standard unit of measurement) and having 114 calories, there is no predefined or known relationship between the default serving size of “1 banana” and any standard unit of measurement. However, the other consumable records in the cluster of related consumable records can be used to estimate an equivalent to “1 banana” in terms of a standard unit of measurement. Particularly, another consumable record may exist for a banana having a serving size of “126 grams” and 114 calories. Since the two records have the same number of calories, it can be inferred that a 114 calorie banana weighs roughly 126 grams. Accordingly, the processing circuitry/logic 304 can generate an additional serving size of “126 grams” based on this learned relationship between the non-standard unit of measurement “bananas” and the standard unit of measurement “grams”.

Additionally, the cluster of related consumable records can be weighted based on a number of calories of each record. For example, if a first consumable record for a banana has a serving size of “118 grams” and 108 calories and a second consumable record for a banana has a serving size of “100 grams” and 89 calories, it can be calculated that bananas have roughly 0.9 calorie per gram

$$( i . e . , AVG ( \frac{108 cal}{118 grams} , \frac{89 cal}{100 grams} ) \approx 0.9 cal \text{/} gram )$$

(note that the average, “AVG,” indicated above is a mean, but any number of different mathematical means may be used to calculate the average such as a median or mode; moreover, any number of different calculations may be used to arrive at the estimated serving size for a consumable based on existing consumable records, including a confidence score for each consumable record and a related weighted average). Accordingly, the processing circuitry/logic 304 can generate an additional serving size of “1 gram” which shows proportional calories (e.g., 0.9 calories) and other proportional nutritional contents when the user attempts to log consumption of a banana. This is particularly useful if the user can simply weigh his or her portion of bananas on a scale and can enter an exact number of grams as the number of servings.

In addition to the above, the cluster of related consumable records can also be used to estimate a relationship between a standard unit of weight and a standard unit of volume. For example, the selected consumable might be raw broccoli having a serving size of “1 cup” and 20 calories. In order to offer the user with the option of logging the serving size of the broccoli by weight instead of volume, the processing circuitry/logic 304 identifies a cluster of consumable records that are related to raw broccoli. If a first consumable record of a raw broccoli cluster has a serving size of “54 grams” and 15 calories and a second consumable record of the cluster has a serving size of “100 grams” and 27 calories, then the processing circuitry/logic 304 can determine that broccoli has roughly 0.27 calories per gram

$$( i . e . , . AVG ( \frac{27 cal}{100 grams} , \frac{15 cal}{54 grams} ) \approx 0.274 cal \text{/} gram ) .$$

Therefore, 1 cup of raw broccoli is roughly equal to 73 grams

$$( i . e . , \frac{20 cal}{0.274 cal \text{/} gram} \approx 73.022 grams ) .$$

Accordingly, the processing circuitry/logic 304 can generate the additional serving sizes of “73 grams” (equivalent to “1 cup”) and “1 gram” based on these learned relationships. When these serving size options are presented to the user, the user may select a desired serving size and a desired number of servings to accurately reflect food consumed by the user.

Additionally, the cluster of consumable records might include a third consumable record that has a serving size of “5 florets” and 21 calories. From the third consumable record, the processing circuitry/logic 304 can determine that one floret is roughly equal to 15 grams

$$( e . g . \frac{21 cal}{5 florets} * \frac{gram}{0.274 cal} \approx 15.33 grams \text{/} floret ) .$$

Accordingly, the processing circuitry/logic 304 can further generate an additional serving size of “1 floret” (equivalent to 15 grams) based on this learned relationship. Accordingly, a number of different serving size options may be presented to the user for broccoli (e.g., florets, cups, grams, etc.) and the user may select the desired serving size and a desired number of servings to accurately reflect food consumed by the user.

In some embodiments, the processing circuitry/logic 304 is configured to parse the text strings that identify the serving sizes of each record of the cluster of consumable records into tokens. Similar tokens can be grouped together and categorized as the same token. For example, if the cluster of consumable records has serving sizes including the tokens: “piece”, “pieces”, and “peices”, the tokens can be categorized as the same unit of measurement or otherwise normalized to remove the plural terms and/or incorrectly spelled terms. Additionally, tokens that are found in the text strings that identify the serving sizes, but that do not represent a serving size can be removed. For example, if a consumable record has a serving size of “3 pieces with liquid” or “2 pieces (dry)”, the tokens “with liquid” and “(dry)” can be ignored or removed.

Relationships between different units of measurement can also be determined by parsing serving sizes that are listed with two units or by parsing descriptive strings associated with the consumable. For example, if a consumable record has a serving size of “10 pieces (42 g)”, it can be learned that 10 pieces is equal to 42 grams. As another example, if a consumable record is labeled “Double Cheeseburger (162 g)” and has a serving size of “1 burger”, it can be learned that one burger is equal to 162 grams. Accordingly, the processing circuitry/logic 304 can further generate the additional serving sizes of “162 grams” and “1 burger” based on these learned relationships.

In some embodiments, the processing circuitry/logic 304 may generate conflicting conversions between units of measurement depending on which consumable records are used for comparison. For example, a first comparison with a first consumable record may indicate that three pieces is equal to 50 grams. However, a second comparison with a second consumable record indicates that three pieces is equal to 60 grams. In such an instance, in one embodiment, the processing circuitry/logic 304 is configured to assign a confidence score the first consumable record and the second consumable record. The confidence score indicates likelihood that the corresponding consumable record has accurate nutritional data. In one embodiment, the confidence score is equal to a number of times that the consumable record has been logged by users of the health tracking system 100. For example, if the first consumable record has been logged ten times, it has a confidences score of 10. If the second consumable record has been logged 20 times, it has a confidence score of 20. The processing circuitry/logic 304 is configured to estimate the relationship between the units of measurement by a weighted average of the conversions. Particularly, the processing circuitry/logic 304 estimates that three pieces is equal to 56.6 grams, with a confidence score of 15.

In another embodiment, a confidence may be applied using the methods and apparatus discussed in co-owned, co-pending U.S. patent application Ser. No. 15/087,646 filed on Mar. 31, 2016 and entitled “ Health Tracking System with Verification of Nutrition Information”, which is incorporated herein by reference in its entirety. As discussed therein, a health tracking system including a plurality of health tracking devices in communication with a host server is provided. In one embodiment, a method of operating the system comprises: receiving data relating to consumables from user devices; storing the data as data records; grouping the data records into groups based on a description string of each; determining an individual score to associate to each data record; and applying an identifier to one of the data records in each group, the one of the data records comprising a one associated with a high score relative to the remaining ones of the data records in the group. These and other methods for providing a verification or confidence score to consumable records are disclosed.

Additionally, a third comparison with a third consumable record, which has only been logged twice (and has a confidence score of only two), might indicate that seven pieces is equal to 60 grams. This conversion clearly conflicts with the other conversions based on comparisons with the first and second consumable records. Since the confidence score is only two, this conversion with a low confidence score can be filtered out before the processing circuitry/logic 304 performs the weighted average.

While the foregoing provides an example of the confidence score being equal to a number of times that the consumable record has been logged by users, it will be recognized that the confidence score for consumable record may be determined in any number of different ways. For example, the confidence score may be based at least in part of the user or organization that logged or otherwise provided the consumable record (e.g., consumable records based on information provided from the USDA may have a significantly higher score than a consumable record provided by a one-time user), reports of the record being incorrect, and any number of additional factors used separately or in combination.

### Ranking of the Serving Size Options

As discussed above with respect to FIG. 9, the GUI of the smartphone 200 shows a menu 910 of serving size options that encourage the user to select a desired serving size when logging a consumable. In this embodiment, the menu 910 of serving size options may indicate a ranking of serving sizes in order to assist the user in selecting the most appropriate serving size for the consumable to be logged. In one embodiment, the processing circuitry/logic 304 is configured to execute program instructions in the memory 306 to generate a ranking of the plurality of serving sizes of a consumable record and provide the ranking to the smartphone 200. Alternatively, the processor 208 of the smartphone 200 or a processor of another health tracking device 110 is configured to generate the ranking of the plurality of serving sizes. In one embodiment, the GUI is configured to display the serving size options in order on the menu 910 according the provided ranking. Additionally, in at least one embodiment, the GUI is configured to display an icon or other notation (e.g. an asterisk) suggesting to the user that the displayed serving size is the recommended or preferred serving size based on the provided ranking. In this manner, the system 100 is configured to assist the user in selecting the most appropriate serving size units when logging foods and beverages consumed by the user.

In some embodiments, the serving sizes are ranked on the basis of a locale or region of the user. For example, if a user's profile indicates that he or she resides in a country that typically uses metric units of measurement (e.g., grams), then serving sizes having metric units of measurement are ranked higher than serving sizes having imperial units of measurement (e.g., ounces or cups). Accordingly, metric unit serving sizes will typically be higher ranked for users in continental European countries, while imperial unit serving sizes will typically be higher ranked for users in the United States.

In some embodiments, the serving sizes are ranked according to a popularity of each of the plurality of serving sizes. For example, serving sizes that are used more frequently are ranked higher than serving sizes that are used infrequently, or vice versa.

In some embodiments, the serving sizes are ranked according to a confidence score that indicates a likely correctness of the serving size. This confidences score may be the same or different from the confidence score discussed above with respect to generating additional serving sizes. Serving sizes having high confidence scores are ranked higher than serving sizes having lower confidence scores, or vice versa. The default serving size may be automatically provided with the highest confidence score.

In some embodiments, the serving sizes are ranked according to user preferences. For example, a user might select a preferred unit of measurement for weights and a preferred unit of measurement for volumes. Serving sizes having the preferred units of measurement are rank higher than serving sizes having other units of measurement.

The methods discussed herein may be accomplished with the assistance of a computer program, such as the network and/or client side health tracking programs described above. The above described system and method solves a technological problem common in industry practice related to effective and efficient presentation of serving size data. Moreover, the above-described system and method improves the functioning of the computer/device by allowing health data to be effectively communicated to the user along with a graphical user interface that presents food item serving size selection options to the user.

Portions of the system and methods described herein may be implemented using one or more programs or suitable software code, such as the network and/or client-side health tracking applications, described above, each of which may reside within the memory of the respective computing devices as software or firmware. Such programs and code may be stored in the memory and executed by the processor of the display device or a system server or other computer in communication with the display device. A computer program product implementing an embodiment disclosed herein may therefore comprise one or more computer-readable storage media storing computer instructions translatable by processing circuitry/logic, a CPU, or other data processing device to provide an embodiment of a system or perform an embodiment of a method disclosed herein. Computer instructions may be provided by lines of code in any of various languages as will be recognized by those of ordinary skill in the art.

A “computer-readable medium” may be any type of data storage medium that can store computer instructions and/or data, including, read-only memory (ROM), random access memory (RAM), hard disks (HD), data cartridges, data backup magnetic tapes, floppy diskettes, flash memory, optical data storage, CD-ROMs, or the like. The computer readable medium can be, by way of example, only but not by limitation, an electronic, magnetic, optical, electromagnetic, infrared, or semiconductor system, apparatus, system, device, or computer memory. The computer readable medium may include multiple computer readable media storing computer executable instructions, such as in a distributed system or instructions stored across an array. A “non-transient computer-readable medium” may be any type of data storage medium that can store computer instructions, including, but not limited to the memory devices discussed above.

The above described system and method solves a technological problem common in industry practice related to effective and efficient presentation of health data to a user for analysis and consideration by the user. Moreover, the above-described system and method improves the functioning of the computer device by causing food and nutrition data to be easily presented to a user in a health tracking system, while also allowing the user to manipulate the serving size of the consumed item in an efficient manner. In the foregoing description, various operations may be described as multiple discrete actions or operations in turn, in a manner that may be helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The foregoing detailed description of one or more exemplary embodiments of the health tracking system has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

What is claimed is:

1. A method of providing nutritional data to a user, the method comprising:
receiving a selection of a consumable item having a descriptor from a health tracking device;
associating the selected consumable item with a consumable record in a database based on a comparison of the descriptor to a descriptive string for of the consumable record;
obtaining from the consumable record a first serving size for the selected consumable item;
calculating a second serving size for the selected consumable, the second serving size having a different unit of measurement than the first serving size; and
providing the first serving size and the second serving size to the health tracking device.

2. The method of claim 1 further comprising:
receiving a plurality of data relating to at least one consumable from the health tracking devices, the plurality of data including the descriptive string and the serving size for the respective at least one consumable;
generating at least one consumable record based on the plurality of data; and
storing the generated at least one consumable record in the database.

3. The method of claim 1 further comprising, before receiving the selected consumable:
receiving a search string from the health tracking device;
associating the search string with a group of consumable records in the database by comparing the search string with the descriptive strings of the plurality of consumable records in the database; and
providing a list of consumables to the health tracking device, the list of consumables including each consumable corresponding to the group of consumable records;
wherein the selection comprises selection from the list.

4. The method of claim 1, the generating of the second serving size for the selected consumable comprising:
identifying a first unit of measurement of the first serving size; and
generating the second serving size having a second unit of measurement based on the first serving size and an equation that converts the first unit of measurement to the second unit of measurement, the second unit of measurement being different than the first unit of measurement.

5. The method of claim 4, wherein the equation is based on a predefined relationship between the first unit of measurement and the second unit of measurement.

6. The method of claim 4, the generating of the second serving size for the selected consumable further comprising:
estimating a relationship between the first unit of measurement and the second unit of measurement based on at least two consumable records of the plurality of consumable records in the database; and
determining the equation based the estimated relationship between the first unit of measurement and the second unit of measurement.

7. The method of claim 6, the estimating of the relationship between the first unit of measurement and the second unit of measurement comprising:
identifying a group of consumable records of the plurality of consumable records that are related to the consumable record associated with the selected consumable based on the descriptive string of the consumable record associated with the selected consumable; and
wherein the act of estimating the relationship between the first unit of measurement and the second unit of measurement is based on a comparison of the consumable record associated with the selected consumable and the identified group of consumable records.

8. The method of claim 7, the estimating of the relationship between the first unit of measurement and the second unit of measurement further comprising:
parsing units of measurement from at least one of (i) the serving sizes of the identified group of consumable records and (ii) the descriptive strings of the identified group of consumable records.

9. The method of claim 8, the estimating of the relationship between the first unit of measurement and the second unit of measurement further comprising:
sorting the parsed units of measurement of serving sizes of the identified group of consumable records into normalized categories.

10. The method of claim 7, the estimating of the relationship between the first unit of measurement and the second unit of measurement further comprising:
identifying a first consumable record of the identified group of consumable records that has a serving size that is in terms of the second unit of measurement; and
wherein the act of estimating the relationship between the first unit of measurement and the second unit of measurement is based on a comparison of the serving size of the consumable record associated with the selected consumable and the serving size of the identified first consumable record.

11. The method of claim 7, the estimating of the relationship between the first unit of measurement and the second unit of measurement further comprising:
identifying a first consumable record of the identified group of consumable records that has serving sizes in terms of both the first unit of measurement and the second unit of measurement; and
wherein the act of estimating the relationship between the first unit of measurement and the second unit of measurement is based on the serving sizes of the identified first consumable record.

12. The method of claim 7, the estimating of the relationship between the first unit of measurement and the second unit of measurement further comprising:
determining a confidence score for each consumable record of the identified group of consumable records, the confidence score indicating a likelihood that a corresponding consumable record has correct nutritional data,
wherein the comparison of the consumable record associated with the selected consumable and the identified group of consumable records is weighted based on the corresponding confidences score for each consumable record.

13. The method of claim 1 further comprising:
generating a ranking of the plurality of serving sizes; and
providing the ranking of the plurality of serving sizes to the health tracking device, the health tracking device being configured to display the plurality of serving sizes to the user according to the ranking.

14. The method of claim 13, wherein the generating of the ranking is based on at least one of:
a locale of the user;
a popularity of the corresponding serving size;
a confidence score for the corresponding serving size, the confidence score indicating a correctness of the corresponding serving size; and
a user preference.

15. A system for providing nutritional data to a user, the system comprising:
an interface configured to receive a selection of a consumable by the user via a health tracking device;
a database configured to store a plurality of consumable records, each consumable record including: (i) a descriptive string for a corresponding consumable, and (ii) nutritional data regarding the corresponding consumable, the nutritional data at least including a serving size associated thereto; and
a data processing system in communication with the health tracking device and the database, the data processing system being configured to (i) receive the selection of the consumable via the interface, (ii) associate the selected consumable with a consumable record in the database, (iii) set a first serving size for the selected consumable as the serving size included in the consumable record associated with the selected consumable, (iv) generate a second serving size for the selected consumable, the second serving size having a different unit of measurement than the first serving size, and (v) provide the first serving size and the second serving size to the health tracking device for display thereat to the user.

16. The system of claim 15, wherein the data processing system is configured to generate the second serving size for the selected consumable by (i) identifying a first unit of measurement of the first serving size, and (ii) generating the second serving size having a second unit of measurement based on the first serving size and an equation that converts the first unit of measurement to the second unit of measurement, the second unit of measurement being different than the first unit of measurement.

17. The system of claim 15, wherein the data processing system is configured to generate the second serving size for the selected consumable by (i) estimating a relationship between a first unit of measurement and a second unit of measurement based on at least two consumable records of the plurality of consumable records in the database, and (ii) determining an equation based the estimated relationship between the first unit of measurement and the second unit of measurement.

18. A non-transient computer readable medium containing instructions for providing nutritional data to a user by:
receiving a selection of a consumable from a health tracking device;
associating the selected consumable with a consumable record in a database, the database including a plurality of consumable records, each consumable record including (i) a descriptive string for a corresponding consumable and (ii) nutritional data regarding the corresponding consumable, the nutritional data at least including a first serving size for the corresponding consumable;
using the first serving size for the selected consumable to generate a plurality of second serving sizes for the selected consumable, the plurality of second serving sizes having a different unit of measurement than the first serving size; and
providing the first serving size and the plurality of second serving sizes to the health tracking device for display thereat to the user.

19. The non-transient computer readable medium of claim 18 further containing instructions for generating the second serving size for the selected consumable by:
identifying a first unit of measurement of the first serving size; and
generating the second serving size having a second unit of measurement based on the first serving size and an equation that converts the first unit of measurement to the second unit of measurement, the second unit of measurement being different than the first unit of measurement.

20. The non-transient computer readable medium of claim 18 further containing instructions for generating the second serving size for the selected consumable by:
estimating a relationship between a first unit of measurement and a second unit of measurement based on at least two consumable records of the plurality of consumable records in the database; and
determining an equation based the estimated relationship between the first unit of measurement and the second unit of measurement.
